(19) United States
(12) Patent Application Publication
(10) Pub. No.: US 2005/0281318 A1
(43) Pub. Date: Dec. 22, 2005

(54) Pseudo noise coded communication systems

(75) Inventor: Charles F. Neugebauer, Los Altos, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: W5 Networks, Inc.

(21) Appl. No.: 11/156,193

(22) Filed: Jun. 16, 2005

Related U.S. Application Data
(60) Provisional application No. 60/580,678, filed on Jun. 17, 2004.
(60) Provisional application No. 60/582,888, filed on Jun. 25, 2004.
(60) Provisional application No. 60/605,568, filed on Aug. 30, 2004.

(51) Int. Cl. H04B 1/713

(52) U.S. Cl. 375/134

(57) ABSTRACT

Systems, apparatus and methods for acquiring code phase and multipath channel models in communication device. A fast Walsh transform engine is used to acquire a pseudo noise code phase and the pseudo noise code bit rate of a radiofrequency signal that has been broadcast. Multipath filter coefficients from the ;pseudo noise code phase and the pseudo noise code bit rate are recovered. A pseudo noise generator is initialized with the pseudo noise code phase acquired during the fast Walsh transform step. The pseudo noise code phase and pseudo noise code bit rate are tracked by a phase locked loop so that communication with the radiofrequency signal is maintained. Then, the received noise code phase and pseudo noise code bit rate are despread so that any data in the radiofrequency signal is recovered.

### CROSS-REFERENCE TO RELATED APPLICATIONS

This application claims priority to U.S. Provisional Application Ser. Nos. 60/580,678, filed on Jun. 17, 2004, 60/582,888, filed on Jun. 25, 2004 and 60/605,568, filed on Aug. 30, 2004. Priority to these prior applications is expressly claimed, and the disclosures are hereby incorporated by reference in their entireties.

This application is related to U.S. patent application Ser. No. ______, filed on Jun. 16, 2005 entitled “Low Power Wireless Communication System And Protocol” and having Attorney Docket Number 16051-4001. The disclosure of this application is hereby incorporated by reference in its entirety.

### FIELD

The present invention relates to pseudo noise coded communication systems and more particularly relates to wireless communication systems having very low cost remote transceiver devices that can be identified by a base transceiver so that the base transceiver and the remote transceiver can exchange data.

### BACKGROUND

There are many applications for communication systems that utilize a base transceivers that can communicate with numerous remote transceiver devices. One type of system involves an architecture where the remote transceiver devices remain turned off for large periods of time. In these systems, the remote transceiver devices turn on periodically for short periods of time so that the base transceiver and remote transceiver devices can communicate, thereby enabling the exchange of data. In such a system, the base transceiver must be able to quickly identify the remote transceiver device that has just turned itself on so that the base transceiver and the remote transceiver device can exchange the appropriate data. Implementation of such systems must clear many obstacles that make deployment difficult.

One obstacle is the remote transceiver device's power consumption. In general, remote transceiver devices receive electrical power from batteries. When power consumption is reduced, the frequency of required battery replacements is decreased. This is important since remote transceiver devices may be placed in hard to reach areas where frequent battery changes are impractical. In addition, even in those situations where remote devices can easily have batteries replaced, doing so can still be difficult, as such communications systems often have thousands, and even hundreds of thousands of remote transceiver devices as part of the network. Frequent battery changes also make maintaining such a system expensive, which is undesirable.

In addition to power consumption issues, communication networks containing thousands of remote transceiver devices are often deployed in environments having radiofrequency (“RF”) noise present. The remote transceiver device must be able to transmit data that the base transceiver can identify in spite of the RF noise. Moreover, the base transceiver must be able to identify the remote device quickly in order for the communication system to have utility.

When a remote transceiver device attempts to communicate with a base transceiver, the base transceiver must be able to interpret the signals being broadcast. Thus, any codes applied to the data must be synchronized with the base station. Traditional methods of synchronization, e.g., placing a crystal in both the remote transceiver device and the base transceiver, are not practical. One reason for this is that crystals use more power than is desirable. Thus, a crystal would significantly reduce battery life. In addition, crystals add significant cost to a communication network since a system employing thousands of remote devices would likewise require thousands of crystals. Added costs of this magnitude are not acceptable.

Communication systems that enable a base station to acquire the signal of a remote device have been attempted. For example, U.S. Pat. No. 6,750,814 describes a known wireless signal acquisition system using FFT based correlation. U.S. Pat. No. 6,163,548 describes a known pseudo noise code synchronization method using fast transforms. U.S. Pat. No. 6,717,977 describes a known apparatus for acquiring pseudo noise code and direct sequence codes. A paper entitled “Fast PN Sequence Correlation by using FWT” by Srdjan Z. Budisin in the Mediterranean Electrotechnical Conference Proceedings, 1989; p. 513-515, describes a known method for using a fast Walsh transform for rapid correlation with pseudo noise codes. A paper entitled “Hardware Implementation for Fast Convolution with a PN Code Using Field Programmable Gate Array” by Abdulqadir Alaqeeli and Janusz Starzyk, Proc. Southeastern Symposium on System Theory, Athens, Ohio, 2001 describes a fast Walsh transform method for rapid acquisition of PN code phase. A paper entitled “On Fast M-Sequence Transforms” by Martin Cohn and Abraham Lempel in the IEEE Transactions on Information Theory, January 1977, p. 135-137, describes an algorithm for efficiently computing multiple correlations with a pseudo noise code.

A paper entitled “An Integrated, Low Power, Ultra-Wideband Transceiver Architecture For Low-Rate, Indoor Wireless Systems”, By Ian D. O'Donnell, Mike S. Chen, Stanley B. T. Wang and Robert W. Brodersen, ______, IEEE CAS Workshop on Wireless Communications and Networking, Sep. 5-6, 2002, provides an example of a pulsed communication system using long pseudo noise (“PN”) codes and a conventional method of PN code phase acquisition. In particular, Section 7 of this paper discusses a parallel PN code phase search and states that such a search is “prohibitively large”. Thus, this paper teaches that PN code phase acquisition should be done serially. However, serial PN code phase acquisition takes a relatively long period of time, which adversely impacts battery life.

None of these references teach or suggest a communication system having base stations or remote devices that provide for fast remote device acquisition, high degrees of noise immunity and low remote device power consumption.

### SUMMARY

An improved code phase acquisition system and method are described herein that performs a fast Walsh transform on a received radiofrequency signal. The fast Walsh transform acquires the pseudo noise code phase and the pseudo noise code bit rate of the radiofrequency signal. Multipath filter coefficients are captured from the pseudo noise code phase and the pseudo noise code bit rate. A pseudo noise generator is then initialized with the pseudo noise code phase acquired by the fast Walsh transform. The pseudo noise code phase and pseudo noise code bit rate are tracked with a phase lock loop to maintain communication with the radiofrequency signal. Once locked, the pseudo noise code phase and pseudo noise code bit rate are despread to recover data in the radiofrequency signal.

The above and other preferred features, including various novel details of implementation and combination of elements will now be more particularly described with reference to the accompanying drawings and pointed out in the claims. It will be understood that the particular methods and apparatus are shown by way of illustration only and not as limitations. As will be understood by those skilled in the art, the principles and features explained herein may be employed in various and numerous embodiments

### BRIEF DESCRIPTION OF THE DRAWINGS

FIG. 1 shows a representative spread spectrum communication model with the pseudo noise (“PN”) spreading applied before the modulator.

FIG. 2 shows a representative spread spectrum communication model with the PN spreading applied after the modulator.

FIG. 3 shows a representative spread spectrum communication model with multiple PN code generators used for modulation.

FIG. 4 shows a representative functional block diagram of the present teachings applied to incoherent signal acquisition.

FIG. 5 shows a representative signal diagram with multiple sub-PN-bit phase sampling instants.

FIG. 6 shows a representative diagram of the three dimensional search space of the acquisition algorithm of the present invention.

FIG. 7 shows an alternative functional block diagram of the present teachings applied to incoherent signal acquisition.

FIG. 8 shows a functional block diagram of the present teachings applied to incoherent signal acquisition, loop filter locking and data de-spreading.

FIG. 9 shows a functional block diagram of the present teachings applied to incoherent signal acquisition, loop filter locking and data de-spreading using an incoherent multipath filter.

FIG. 10 shows a representative signal diagram using oversampling to capture sub-PN-bit phase samples.

FIG. 11 shows a representative functional block diagram of the present teachings applied to coherent signal acquisition.

FIG. 12 shows a representative functional block diagram of the present teachings applied to coherent signal acquisition, code locking and data de-spreading using a coherent RAKE multipath filter.

FIG. 13 is a flow chart showing a method for incoherent PN code phase acquisition, according to an embodiment disclosed herein.

FIG. 14 is a flow chart showing a method for coherent PN code acquisition, according to an embodiment disclosed herein.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present invention. The figures do not describe every aspect of the present invention and do not limit the scope of the invention.

### DETAILED DESCRIPTION OF THE DRAWINGS

Each of the additional features and teachings disclosed below may be utilized separately or in conjunction with other features and teachings to provide improved communications systems and methods for designing and using the same. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

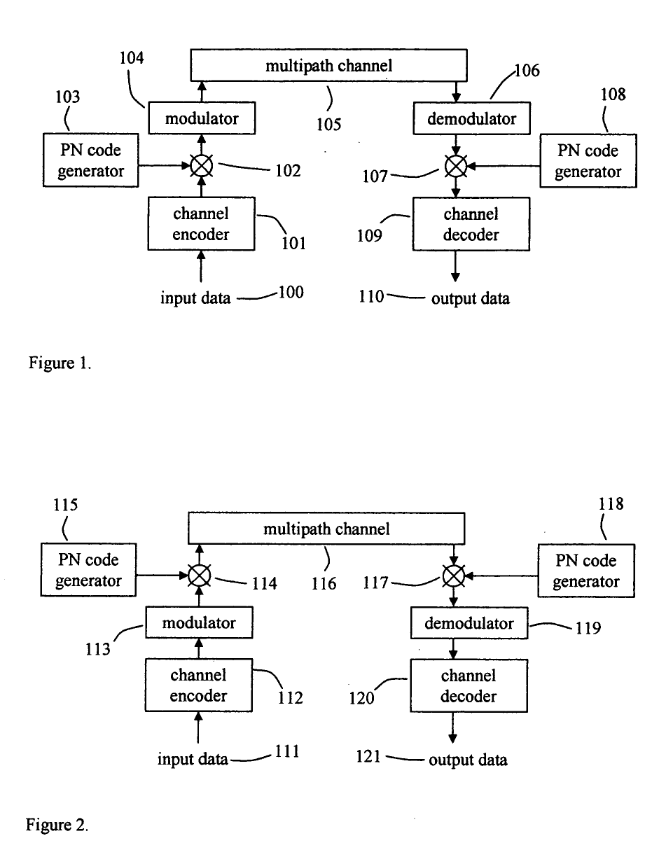

FIG. 1 shows a spread spectrum communication system block diagram with the pseudo noise (“PN”) spreading code applied prior to modulation. Common spread spectrum techniques such as frequency hopping (“FH”) and time hopping (“TH”) can be implemented using the structure of FIG. 1. Modulation methods such as pulse position modulation (“PPM”) and orthogonal frequency division multiplexing (“OFDM”), among others, are compatible with the spread spectrum architecture of FIG. 1. The transmitter, which can be embodied in a remote device, illustrated on the left side of FIG. 1, comprises a source of input data 100, a channel encoder 101, a mixer 102, a pseudo noise (PN) code generator 103 and a modulator 104. In one embodiment, input data 100 includes pilot or beacon signal encoded with a pseudonoise code (PN code) and modulated with any suitable digital modulation technique. A multipath channel 105 (i.e., the environment in which the communication system is operating) carries the transmitted information, introducing such corruptions as multipath reflections, frequency selective fading, noise, and narrow and wideband interference. The receiver, which can be embodied in a base station, illustrated on the right side of FIG. 1, comprises a demodulator 106, a second mixer 107, a second PN code generator 108, a channel decoder 109 and an output data stream 110.

In this embodiment, the input data 100 to be transmitted is encoded into a waveform by channel encoder 101. There are numerous forms of channel encoding and decoding that can be used, for example block codes, convolutional codes, turbo codes and low density parity checking codes. This embodiment is not limited with respect to the choice of coding and decoding methods.

The PN code generator 103 in the transmitter produces a deterministic stream of bits that are combined with the encoded data stream from 101. In one embodiment, the PN code generator 103 outputs a bitstream that has noise like properties and appears nearly random. For most spread spectrum systems, the PN code stream rate is usually a multiple of the input data stream rate (e.g. 10:1). The mixer 102 combines the deterministic higher speed (wideband) PN code with the low speed (narrowband) input data to make a wideband combined signal. The combined signal from the mixer 102 drives modulator 104, which transmits the wideband signal through the channel 105. The channel 105 corrupts the data with noise, fading, multipath reflections, interference, etc. before it arrives at the demodulator 106, which demodulates the signal as well as the channel corruptions introduced in the multiband channel. The receiver's PN code generator 108 generates the same PN code sequence in synchronization with the transmitter's PN code generator 103. The spreading function is reversed and the original narrowband data signal is recovered, as is well known in the art. The channel decoder 109 decodes the resultant bit stream to produce the output data 121. The reduction in bandwidth of the signal by mixer 107 is a direct consequence of the synchronized wideband signals used to broaden and narrow the signal at mixer 104 and 106. The narrowing of the signal at mixer 107 also improves the signal to noise ratio of the received data stream in proportion to bandwidth reduction. This increase in signal to noise ratio is referred to as processing gain. Processing gain is also related and often defined as proportional to the spreading code rate over the encoded data rate. For a spreading code rate that is 10:1 faster than the encoded symbol rate, the processing gain is 10*log(10)=10 dB.

In one embodiment, the modulator 104 and demodulator 106 are linear or nearly linear. Linear modulation is modulation that obeys superposition, e.g. modulation(A+B)=modulation(A)+modulation(B), and similarly for demodulation, e.g. demodulation(A+B)=demodulation(A)+demodulation(B). For example, binary phase shift keying (“BPSK”), quadrature phase shift keying (“QPSK”), quadrature amplitude modulation (“QAM”), orthogonal frequency division multiplexing (“OFDM”), amplitude modulation (“AM”), frequency modulation (“FM”), pulse amplitude modulation (“PAM”), on-off-keying (“OOK”) and pulse position modulation (“PPM”) are all examples of linear modulation methods compatible with the present teachings. The present teachings are not limited with respect to the modulation and demodulation scheme for the architecture of FIG. 1 except that they should be linear or nearly linear. See “Digital Communications, 4^{th} Edition” by John G. Proakis, McGraw Hill, 2001 for a discussion of spread spectrum communications, encode/decode methods and modulation/demodulation methods.

PN code generator 103 and PN code generator 108 each create a pseudo random series of bits that approximate noise but are in fact deterministic and cyclic. One class of PN codes, known as maximal length sequences (M-sequences), can be generated by linear feedback shift registers (“LFSR”). For an LFSR with N bits, the M-sequence binary code will have a length of 2^{N}−1. M-sequences and other PN codes such as JPL codes, Gold codes and Kasami codes are well known in the art and need not be described here. The present disclosure relates to M-sequences and related PN codes, such as polyphase PN sequences and JPL codes. Alternatively, other spreading codes such as Walsh or Hadamard functions may be used for code generators 103 and 108. The present teachings are not limited by the spectral properties of the spreading codes.

FIG. 2 shows an alternative embodiment of a spread spectrum system. The main difference between the embodiment illustrated in FIG. 2 versus the embodiment illustrated in FIG. 1 is the location of the mixers. In the embodiment illustrated in FIG. 2, the mixer 114, is inserted after the modulator 113. Direct sequence spread spectrum (“DSSS”) modulation is a common technique that can be represented by FIG. 2. The transmitter, which can be embodied in a remote device, illustrated on the left side of FIG. 2. The transmitter comprises an input data source 111, a channel encoder 112, a modulator 113, a mixer 114 and a PN code generator 115. In one embodiment, input data 111 includes a pilot or beacon signal encoded with a pseudonoise code and modulated with any suitable digital modulation technique. The multipath channel 116, which represents the environment the communication system operates in, carries and corrupts the signal broadcast by the transmitter, to the receiver, which illustrated on the right side of FIG. 2. The receiver comprises a second mixer 117, a second PN code generator 118, a demodulator 119 and a channel decoder that produces the output data stream 121.

In one embodiment, as opposed to the embodiment described in FIG. 1, the modulator 113 and demodulator 119 can be nonlinear as well as linear, covering most if not all modulation schemes including those mentioned above, including continuous phase frequency shift keying (CPFSK) and continuous phase modulation (CPM), two well known nonlinear modulation schemes.

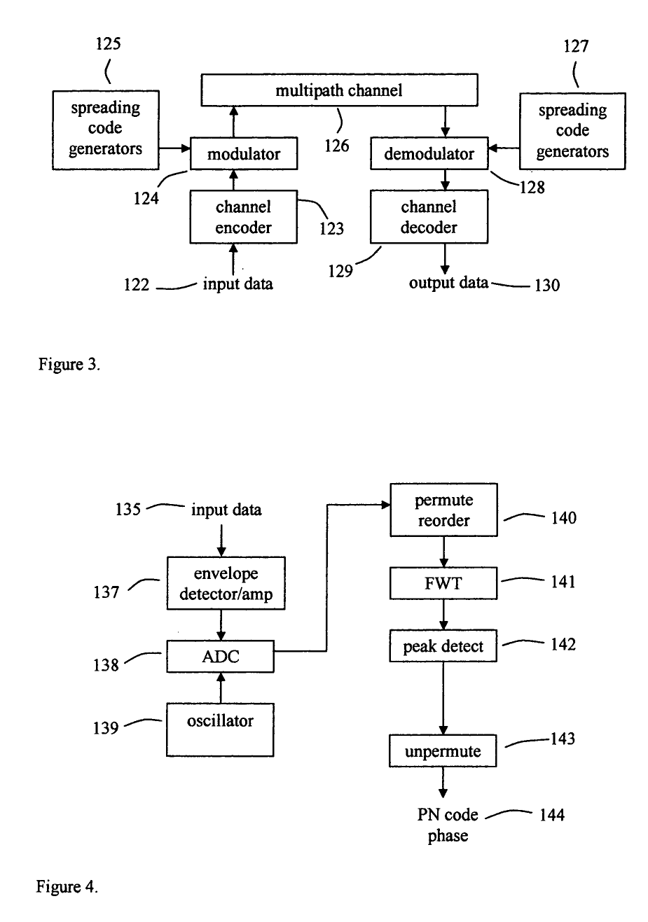

FIG. 3 shows another form of a spread spectrum system wherein the modulation makes use of multiple PN spreading code sequences. Examples of modulation methods that apply to FIG. 3 are cyclic code shift keying (“CCSK”), complementary code keying (“CCK”, used in 802.11), code shift keying (CSK), Barker code position modulation (“BCPM”), M-ary orthogonal keying (MOK), M-ary bi-orthogonal keying (MBOK) and orthogonal code division multiplexing (“OCDM”), among others. The present teachings are not limited by the form of modulation applied in FIG. 3.

A transmitter used in this embodiment of a communication system is illustrated in the left side of FIG. 3. Channel encoder 123 encodes input data 122. Spreading code generators 125 create multiple PN, orthogonal or nearly orthogonal bit streams that are fed into a modulator 124 along with the encoded data. The modulator 124 selects or combines these codes with the encoded signal and transmits the combined signal through the multipath channel 126, i.e., the environment in which the communication system operates. A receiver, illustrated on the right side of FIG. 3, receives the signals broadcast through the multipath channel 126.

The code generators 125 can create two M-sequences that are selected by the encoded data bits in modulator 124 and transmitted into the multipath channel 126. In one embodiment, the spreading code cycle period is equal to the encoded symbol rate.

The signal transmitted through the multipath channel 126 is fed into the receiver demodulator 128 by combining the incoming signal with a synchronized set of matching spreading codes from spreading code generator 127. In one embodiment, the demodulator 128 is comprised of one or more correlators that correlate the incoming signal with the spreading codes.

In order to recover the signal correctly, the PN or spreading code generators on either side of the channel (103 and 108 in FIG. 1, 115 and 118 in FIG. 2, 125 and 127 in FIG. 3) must be synchronized. In traditional communication systems, crystals in the transmitters and receivers would synchronize signals being transmitted and received. As discussed, placing crystals in the transmitters disclosed herein introduces cost and power consumption disadvantages that the present teachings seek to overcome.

M-sequence and other PN sequences often have a narrow (one bit) wide autocorrelation peaks, which while helpful for channelization in a code division multiple access (“CDMA”) system, present problems when synchronizing the transmit and receive PN code phases. Fast acquisition is especially important in low power episodic communication schemes, where radios may enter prolonged and sometimes indeterminate powered down sleep periods to reduce total battery consumption. In particular, an efficient method for rapid PN code phase acquisition is desired to minimize power consumption. Mathematically, code phase acquisition is a sliding correlation or convolution problem.

Fast transform methods have been applied to speed the code phase acquisition problem and fall into two categories. Fast Fourier transform (FFT) based approaches typically compute the FFT of the incoming samples and do a point-by-point complex multiply with a reference vector that is the FFT of the desired PN code vector. The resultant product vector is fed through an inverse FFT, generating an output vector equal to the convolution of the PN code and the input samples at all possible shifts. The particular PN code phase of input signal creates a peak within the output vector.

The second fast transform approach is based on the fast Walsh transform (“FWT”), also known as the fast Hadamard transform (FHT). Walsh transforms have a special relationship with M-sequence PN codes wherein the columns of the transform matrix can be permuted to create a new matrix whose rows are sequential shifts of a given PN M-sequence. Applied to the code phase search problem, the incoming data is first permuted, then fed through a FWT, then unpermuted. The output vector will have a peak at the dominant PN code phase in the input data. The FWT has advantages over the FFT, as it requires only additions and subtractions, significantly reducing hardware requirements.

In many communication systems, a beacon or pilot reference signal is used to synchronize the transmitter and receiver. The beacon allows the rate of the PN sequence to be set at both the transmitter and receiver so that only the code phase of the transmitter needs to be recovered at the receiver. Other systems, such as those discussed above, rely on stable frequency references (e.g., crystals) that similarly set the PN sequence rate at both transmitter and receiver to a value that is accurate enough such that again only the phase of the PN code generator needs to be recovered.

In still other systems, such as the global positioning system (“GPS”), the PN code cycle is very long and frequencies can be significantly shifted by the Doppler effect due to high relative velocity between transmit and receive. In such cases, a two dimensional search is needed to vary both code phase and code frequency.

For pulsed communication systems using PN spreading sequences, there are no present methods to determine PN code phase and frequency using fast or accelerated algorithms such as FWT or FFT. The various teachings herein provide for fast acquisition of PN code phase in pulsed systems.

In one embodiment of the present teachings, a method for recovering the code phase, frequency and the sub-sample phase of the received signal using a three dimensional search is provided. This method is useful for recovering code phase, frequency and multipath channel characteristics that can be used for multipath filter (e.g., RAKE) coefficients. In addition or in the alternative, in low power radio systems with episodic or pulsed communications, the receiver can periodically shut down during each received bit period without suffering effects of sample aliasing. In one embodiment, the transmitter sends a PN M-sequence encoded signal and the receiver determines the phase, frequency and sub-sample phase.

FIG. 4 shows a representative block diagram of an incoherent synchronization mechanism for determining the code frequency, code phase and sub-PN-bit phase of a M-sequence PN coded signal. Circuitry implementing this architecture will generally be found in a remote transceiver. Input data 135 is fed into envelope detector/amp 137. In one embodiment, input data 135 includes a pilot or beacon signal encoded with a PN code and modulated with any suitable pulsed modulation technique. In addition or in the alternative, one or more mixers (not shown), one or more filters (not shown) and/or one or more additional amplifiers (not shown) can be used to translate the input signal to its baseband state prior to or as part of envelope detection. The output of envelope detector/amp 137 is an envelope signal. Note that other front-end radio receiver architectures that are known to those having ordinary skill in the art can also be used.

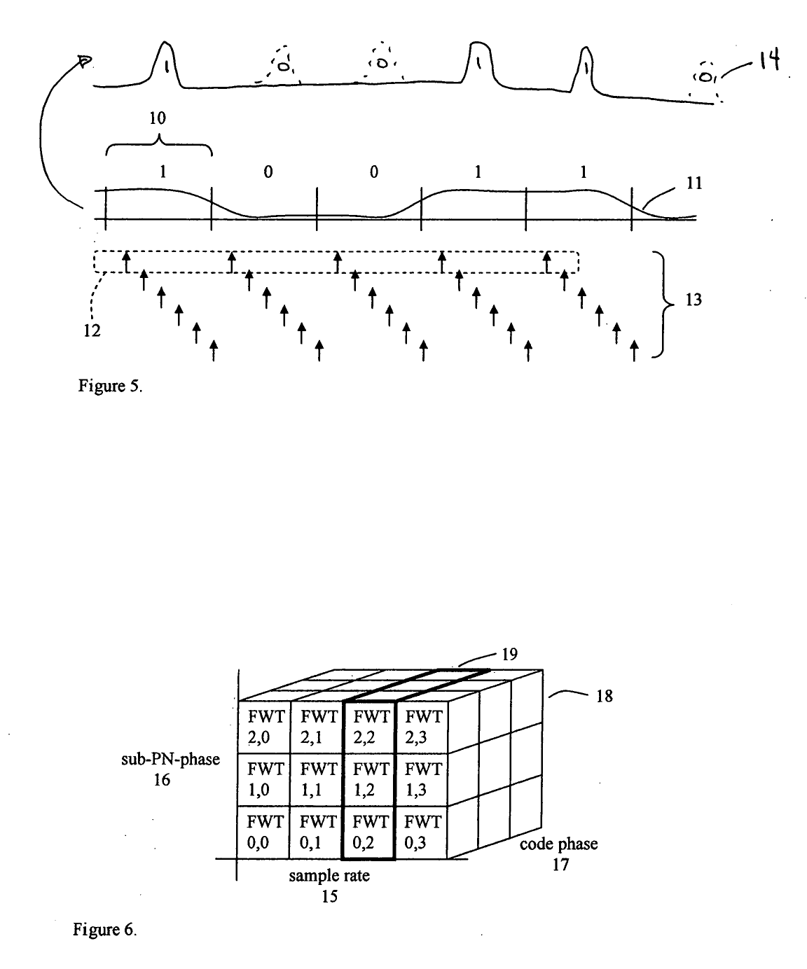

Analog to digital converter (“ADC”) 138 receives and digitizes the envelope signal. In another embodiment, the digitization occurs prior to the envelope detection, thereby allowing the envelope detection to be implemented in digital circuitry. FIG. 5 shows an example of a digitized M-sequence coded signal 11 as seen at the output of the ADC 138. In an alternative embodiment, the output of the ADC 138 can be a pulse signal 14, also seen in FIG. 5. The ADC 138 samples the envelope detector output at a rate and phase determined by programmable oscillator 139, e.g., a voltage controlled oscillator, which is seen in FIG. 4. Note that the various teachings herein allow for the use of a very low cost, low precision oscillator and eliminate the need for a crystal. A vector of 2^{N}−1 sequential samples is collected, where the length of the M-sequence is 2^{N}−1. The vector of samples is reordered according to permute mapping. The permuted vector of samples is fed into a FWT engine 141, which performs a fast Walsh transform. The output of the FWT engine 141 is fed into a peak detector 142 which can determine the maximum output of the FWT engine 141 result. The unpermute function 143 can map the peak position into a code phase.

FIG. 6 provides a representation of the three dimensional search space of the acquisition algorithm of the present invention. As seen in FIG. 6, the oscillator 139 (seen e.g., in FIG. 4) is scanned over all sample rate 15 and sub-sample phase 16 combinations that cover the time range of interest. The range of interest is the search extent and depends upon how far the local oscillator drifted while the device is not transmitting (i.e., while the device is in sleep mode), or has been affected by other factors such as component aging, ambient temperature, battery voltage, etc. In FIG. 5, a set of possible sampling points 13 corresponding to various sub-sample phases is shown. Each set of sampling times 12 is used for each FWT 18 shown in FIG. 6. At each sample rate and sub-sample phase, 2^{N}−1 samples are accumulated and processed by the FWT engine 141. For each sample rate and sub-sanple phase, the peak detector 142 determines the largest correlation within the sampled data set (2^{N}−1 points) with the target PN M-sequence. The oscillator sample rate and sub-sample phase with the maximum peak from peak detector 142 is determined to be the best match code phase, frequency (i.e., sample rate) and sub-sample phase.

In another embodiment, the oscillator 139 is scanned only over the last known sample rate and sub-sample phase and the immediate neighboring rate and phase operating points. The search algorithm can follow the gradient of the peak correlation to achieve an optimum result. Local search methods and other optimization techniques are well known in the art, the choice of which is not limiting with respect to the present teachings.

In one embodiment, the receiver analog front end is only active for a short period during each PN bit period in order to save power. For example, the receive envelope detector/amp 137 might only be active for 10 ns during a PN bit period of 100 ns. This short duration sampling can cause a conventional search in code phase and sample rate to miss the signal peak. In this embodiment, the sub-sample phase search is required to successfully acquire the signal.

In another embodiment, the input signal is modulated using amplitude modulation (AM), pulse amplitude modulation (PAM) or on-off keying (OOK) modulation.

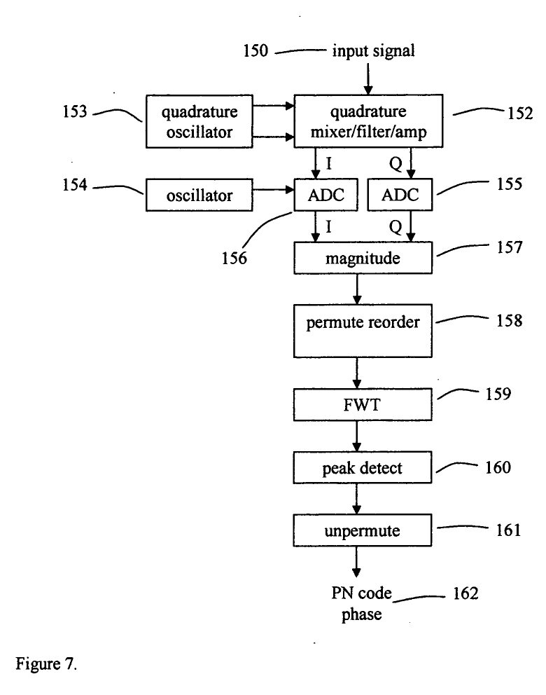

FIG. 7 shows an alternative implementation of an incoherent receiver for signal code phase acquisition, which as discussed above, will typically be located in remote transceivers. The input signal 150, comprises a pulsed pilot or beacon signal, e.g., a pulsed amplitude modulated signal encoded with a PN code, is fed into a quadrature mixer/filter/amp 152, which contains at least one mixer, one or more optional amplifiers, and one or more optional filters to convert the input signal 150 to a quadrature baseband or intermediate frequency state. Such analog front end down conversion procedures are well known in the art and the present teachings are not limited by the implementation details of the quadrature downconverting front end. A quadrature oscillator 153 produces two reference signals for down conversion with a relative phase of 90 degrees. The quadrature mixer/filter/amp 152 creates two quadrature outputs, I and Q, that are digitized by ADCs 155 and 156 at a sample rate and phase determined by oscillator 154. The digitized signals are combined within magnitude calculator 157. In one embodiment, the magnitude calculator computes the root mean square (“RMS”) of the I and Q inputs, i.e. output=sqrt(I²+Q²). In an alternative embodiment the magnitude calculator can sum the absolute values of I and Q, i.e. output=abs(I)+abs(Q). The present teachings are not limited by the choice of magnitude calculation 157. The quadrature down conversion front end architecture is often preferred over an envelope detector front end, such as in FIG. 4, as the carrier frequency is easily tunable over a broad range, out of band signals/noise are more easily rejected and less expensive components can often be used.

The output of the magnitude calculation 157 is collected into a vector of 2^{N}−1 samples as before for a M-sequence length of 2^{N}−1. This vector is then fed into a permute reorder 158 followed by a FWT 159. The output of the FWT 159, a vector with 2^{N}−1 points equal to the permuted convolution of the target M-sequence and the input sample vector, is fed into a peak detector 160. The index output of the peak detector 160, i.e. the index of the peak, is fed through an unpermute function 161 to indicate the found code phase of the input signal M-sequence. This code phase can be subsequently used to synchronize the receiver's PN generator(s) (e.g. 108, 118, or 127) to the transmitter's PN generator(s) (e.g. 103, 115 or 125) as required for spread spectrum communication.

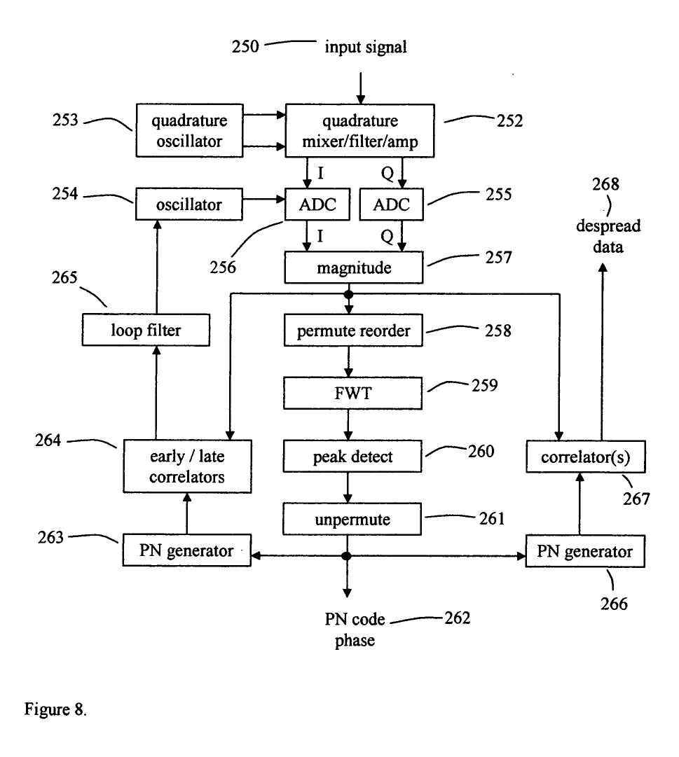

FIG. 8 shows a representative block diagram of an alternative incoherent code acquisition system that includes a frequency locking mechanism and data despreader that can be implemented in a remote transceiver. The input signal 250, which includes a pilot or beacon signal encoded with a PN code is fed into a quadrature mixer/filter/amp 252, which contains at least one mixer, one or more optional amplifiers, and one or more optional filters to convert the input signal 150 to a quadrature baseband or intermediate frequency state. Such analog front end down conversion procedures are well known in the art and the present teachings are not limited by the implementation details of the quadrature downconverting front end. A local quadrature oscillator 253 provides the quadrature mixer/filter/amp 252 with two reference signals that are nominally 90 degrees out of phase. The outputs of the mixer/filter/amp 252 are digitized by ADCs 255 and 256 and then fed into a magnitude calculator 257, similar in function to 157 described above. The ADCs 255 and 256 are driven by a programmable oscillator 254 that is used to step through various searching frequencies and phases as described above. The output of the magnitude calculator 257 is first fed into a permute reorder 258 that takes 2^{N}−1 samples and reorders them in preparation for a FWT-based M-sequence correlation. The FWT 259 is performed on the permuted samples and the output is fed to a peak detector 260. The output of the peak detector is fed into an unpermute function 261 that gives the PN code phase 262 of the detected peak.

The PN code phase 262 can be used to initialize a PN generator 263 to generate a local version of the received PN code roughly in phase with the detected signal. In one embodiment, the oscillator 254 is programmed to the detected peak frequency and phase setting, 2^{N}−1 new samples are collected and permuted, the FWT is computed and the peak detector 260 and unpermute function 261 are used as before to generate a current PN code phase which is used to initialize PN generator 263. This peak redetect process can be repeated a few times while optionally applying slight variations to the oscillator frequency and/or phase. The purpose of this step is to give the PN correlators 264 and 267 a best current estimate of the current PN code phase. The local PN generator 263 generates the same PN code used in the input signal, roughly in phase. In one embodiment, the PN generator 263 is clocked by the oscillator 254. The PN code generated by 263 is fed into an early/late correlator block 264 which contains at least two correlators that act as a phase detector, providing a signal that is first filtered in loop filter 265 and then sent to oscillator 254 to adjust its frequency in response to the early/late signal. The oscillator 254, ADCs 255 and 256, the magnitude calculator 257, the early/late correlators 264, the PN generator 263 and the loop filter 265 form a phase-locked loop (“PLL”) that tracks the input PN code bit frequency and phase. The initialization of the PN generator 263 by the initial PN code phase allows the loop to start at or near the correct frequency and phase so that the early/late correlators 264 are in range to give a corrective signal. The frequency and phase steps during the FWT search process must be sufficiently fine to allow the components implementing the PLL to lock from the initialized value.

In another embodiment, a second data signal encoded with a second PN code can be sent from the transmitter and superimposed on the first PN code used for the PLL. A second PN generator 266 can generate the same code as the PN data code, which when synchronized with the first PN code phase allows one or more correlators 267 to convert the magnitude calculator 257 output into a despread data stream 268. In a further embodiment, the first PN code used for the lock mechanism is an M-sequence code. In another further embodiment, the second data PN code is an M-sequence code of equal or shorter length to the first PN code used for locking. In an alternative embodiment, the length of the second PN code used for spreading data is a multiple of the length of the first PN code used for the PLL, and the data PN generator 266 must cycle through a number of starting phases until the correlator(s) 267 output is maximized.

Alternatively, the second PN code is not a multiple of the first PN code and an alternative data synchronization method is used. For example, the repetitive beacon sequence of the first PN code of length 2^{N}−1 can be occasionally replaced with an alternative PN sequence of similar or dissimilar length that indicates a frame timing boundary. A second correlator (not shown) monitors the demodulated beacon signal for the existence of this second PN sequence. If the second PN sequence is detected, the transceiver restarts a frame counter (not shown) that then increments on every reception of the first PN sequence. In the case where the data carrying second PN codes are longer than the first PN beacon code, the second code phase can be established deterministically relative to the frame timing boundary. In this manner, a notion of timing sequence longer than the first PN sequence can be synchronized between the base and remote transceivers that facilitates the use of longer second PN codes for data transmission. As will be understood by those skilled in the art, numerous similar frame synchronization methods may be substituted and are within the scope of the present teachings.

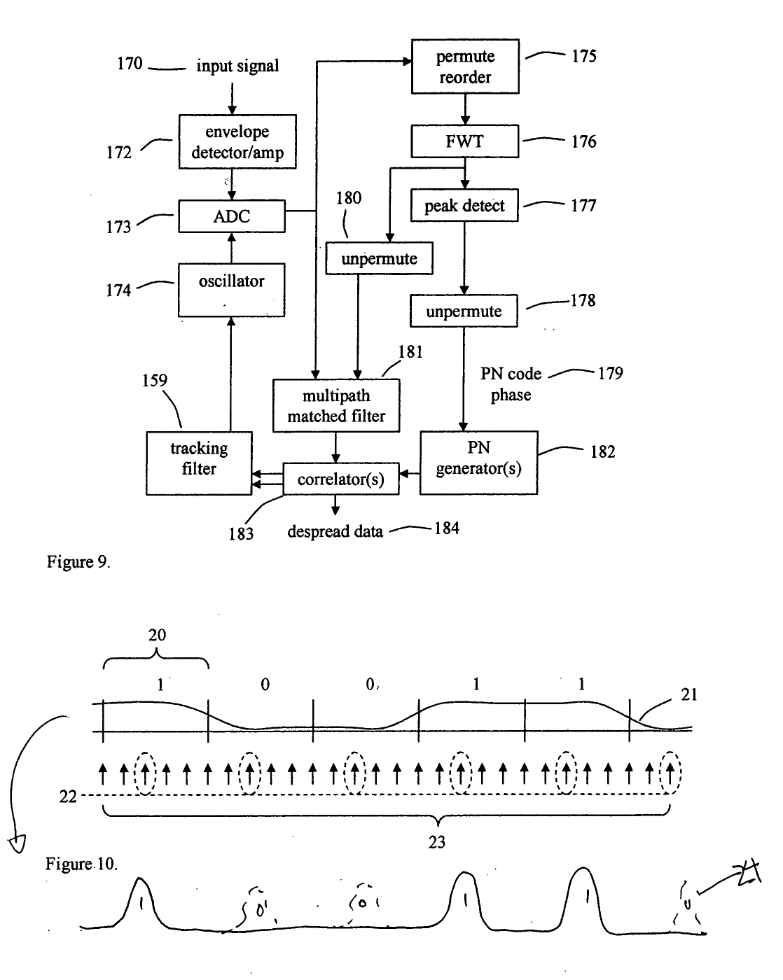

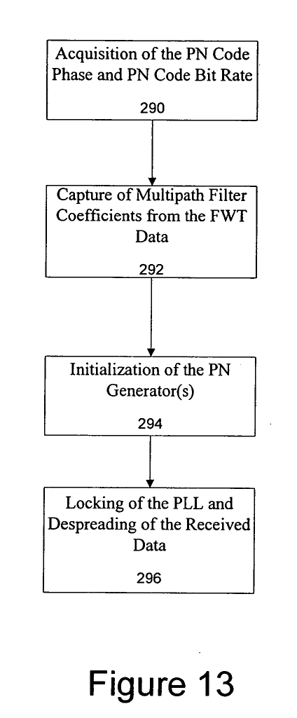

FIG. 9 shows an alternative incoherent block diagram for PN code phase acquisition, PN code locking through the use of a PLL, and a multipath filter. In one embodiment, the operation of the system shown in FIG. 9 consists of four main steps, which can be seen in FIG. 13. The first step is acquisition of the PN code phase and PN code bit rate 290, i.e., determining a nearly correct sample rate. The second step is capture of multipath filter coefficients from the FWT data 292. The third step is initialization of the PN generator(s) 294. The fourth step is locking of the PLL and despreading of the received data 296. Once these steps are complete, the code phase has been acquired and the signal being broadcast has been locked so that the base transceiver and the remote transceiver can exchange data.

Acquisition of the PN code phase and PN code bit rate 290 is accomplished in a manner substantially similar to that described above, namely the input signal 170 having a beacon signal is first detected and converted to a baseband signal by envelope detector/amp 172 or its equivalent. In an alternative embodiment, the envelope detector/amp 172 is replaced with a mixer/filter/amp and down conversion local oscillator (not shown) similar to those described above. The signal is then digitized by ADC 173 at a rate and sub-PN-bit phase set by programmable oscillator 174. The oscillator is sequentially programmed to a series of search points in sub-PN-bit phase/sample-rate space as shown in FIG. 6, at each of which 2^{N}−1 samples are taken and permute reordered by 175. A FWT 176 is performed on each of the permuted data vectors and a peak detector 177 is used to score the results. At the end of the search phase (step 290), the best sample frequency and sub-sample phase are known.

In one embodiment shown in the sampling diagram of FIG. 5, multiple samples are taken for each sub-PN-bit phase 13. Multiple PN bit phase vectors can be assembled, e.g. 12 in FIG. 5, one for each investigated sub-PN-bit phase, which are fed to the FWT engine 176. For example, the ADC 173 can sample with a one nanosecond period (10⁹ samples/sec) for a PN bit period of one hundred nanoseconds (100× oversampling). Similarly, a set of 2^{N}−1 length sample vectors can be assembled for each of the 100 sub-PN-bit phases. The peak determination using the FWT engine 176 and peak detector 177 is done across all one hundred sample vectors. Once the global peak of all one hundred FWT operations is determined, the remaining FWT outputs in the neighborhood of the peak can be recovered to create a time domain model of the multipath channel 105, 116, 126. This multipath model snapshot can be used to program a multipath filter 181.

To capture of multipath filter coefficients from the FWT data, step 292, the FWT results for the winning frequency, e.g., two-dimensional result block 19 of FIG. 6, are programmed into the multipath matched filter 181 as tap weights. The sub-PN-bit phase outputs of the FWT are proportional to the multipath reflections in the incoming signal of the source PN coded signal. In one embodiment, the FWT results of all the search points are stored in a memory (not shown) and the multipath matched filter 181 taps (FIG. 9) are programmed out of this memory once the peak sample rate is known. The FWT results are unpermuted 180 prior to being programmed into this multipath match filter 181. In an alternative embodiment, once the peak sample rate is known, the programmable oscillator 174 is set up to this best frequency and multiple phases are tested to regenerate the FWT results and capture the multipath matched filter 181 coefficients. In an alternative embodiment, the multipath filter coefficients set to a temporary value and are later refined after locking of the PLL and despreading of the received data and once the PLL is locked onto the incoming signal.

To initialize the PN generator(s) 294, the PN generator 182 is initialized with the PN code phase data 179 from the FWT/unpermute function (see e.g., FIG. 9, block 178). In one embodiment, after the search for the best ADC sample rate, the programmable oscillator 174 is set up at the best sample rate. An additional permute/FWT/unpermute is performed to find the current PN code phase 179, which is in turn used to initialize the PN generator(s) 182.

The input signal 170 has data encoded therein. Typically, the input data 170 has multiple messages encoded simultaneously using long PN codes that are superimposed on the signal. To lock the PLL and despread the received data, step 296, the correlator(s) 183 provide a corrective signal to a tracking filter 159 that drives the oscillator 174 to form a PLL. The PLL consists of the oscillator 174, the ADC 173, the multipath filter 181, the correlator(s) 183 and the tracking filter 159. Additionally, the correlator(s) 183 are also extracting the despread data 184, possibly encoded with one or more different PN codes than that used in the PLL. In addition, once the PLL is locked, a series of FWTs or correlations can be performed to set, refine or track the multipath matched filter 181 coefficients.

Each of the steps 290, 292, 294 and 296 associated with FIG. 9 may be performed independently or in a different order as prescribed above. The present teachings are not limited with regard to the order, combination or substitution of these listed steps with other known or described steps.

FIG. 10 shows a baseband input signal waveform 21 with PN code periods 20 and binary values. In an alternative embodiment, the output of the ADC 173 can be a pulse signal 24, also seen in FIG. 10. In one embodiment, the ADCs 138, 155, 156, 256, and/or 257 are clocked at a higher rate than the input PN code bit rate to oversample the signal to get all the sub-PN-bit phase samples, graphically shown as the sampling points 23 in FIG. 9. The permute/reorder blocks (140, 158, 175, 258) then take every k^{th} sample 22 to form a permuted input vector for FWT blocks (141, 159, 176, 259) where k ranges from 0 to P−1, where P is the number of sub-PN-bit phases. For example, an incoming signal with a PN bit period of one hundred nanoseconds can be oversampled by 100× using an ADC clock of 1 GHz. In this example there are one hundred sub-PN-bit phases, each one generating a vector of length 2^{N}−1 samples for FWT processing, which require one hundred FWT operations to process. The resultant multipath resolution would be one nanosecond.

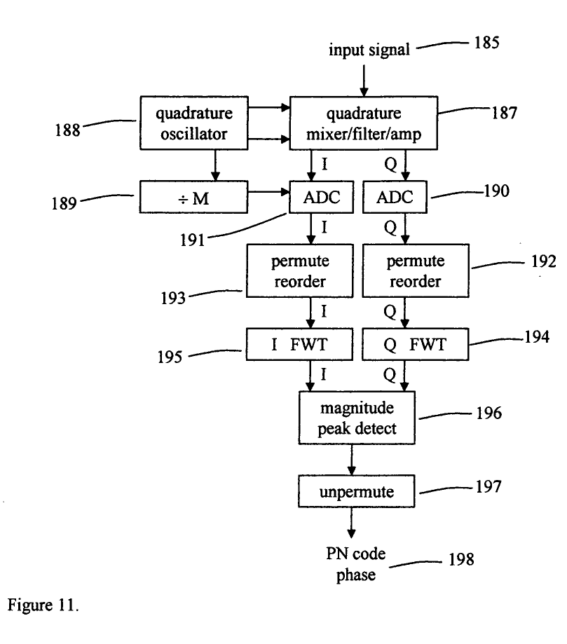

FIG. 11 shows a coherent signal phase acquisition block diagram. The input signal 185 is fed into a quadrature mixer/filter/amp 187 as before which generates I and Q baseband signals. These signals are digitized by ADCs 190 and 191. The quadrature mixer/filter/amp 187 is driven by a local quadrature oscillator 188, which supplies two reference signals 90 degrees out of phase to the mixer for downconverting the incoming signal. The ADCs are driven with a clock derived from the quadrature oscillator frequency using, for example, a divide circuit 189. In one embodiment, the phase relationship between the ADC 190 191 clock and the quadrature oscillator 188 must be relatively fixed and stable to allow coherent detection.

The outputs of each of the ADCs, ADC 190 and ADC 191, are preferably kept separate so that the signal to noise ratio performance is increased. Each quadrature component is permute reordered, seen in blocks 192 and 193. Then, each permute reordered quadrature component is fed into FWTs 194, 195 for processing. The output of the FWTs 194 and 195, at block 196, is combined to find the magnitude of the complex correlation. By performing the magnitude/peak detection after despreading, the signal to noise ratio is increased. The peak detection 196 determines the peak of the FWT results which is then remapped by the unpermute function 197 to generate the output PN code phase 198. The advantages of coherent detection include a superior ability to reject noise and higher processing gain when compared to incoherent detection. In order for coherent detection to work properly, however, the quadrature oscillator 188 and ADC sample rate generated by block 189 must have a fixed phase relationship. There are many ways known in the art for fixing a phase relationship between two oscillators, including division, phase-locked loops (PLLs) and delay locked loops (“DLL”). The present teachings are not limited with respect to the method of maintaining a fixed phase relationship between the ADC sample rate and the quadrature oscillator 188. Note system implementing coherent detection will be more expensive than those implementing incoherent detection because of the need for fixing the phase relationship between the oscillator 188 and the ADCs 190, 191.

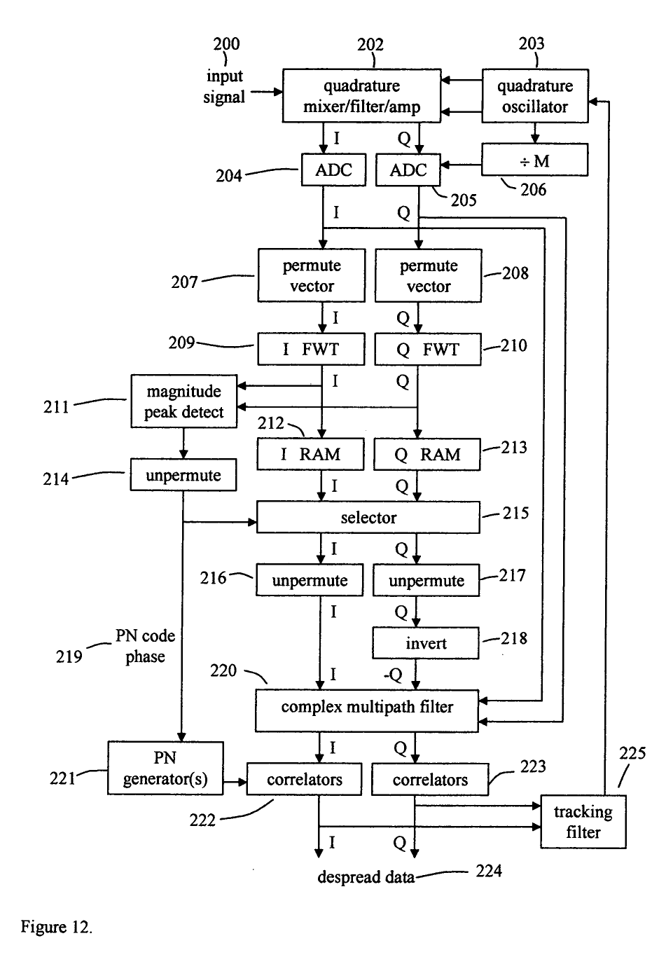

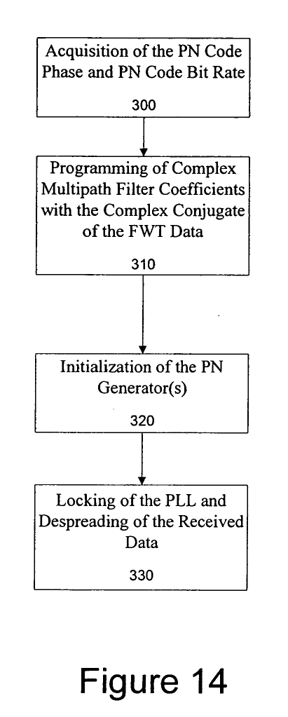

FIG. 12 shows a coherent PN code phase acquisition, complex multipath filter and data despreading system block diagram based on the coherent PN code acquisition system of FIG. 11. In one embodiment, the system of FIG. 12 performs the following method, which is illustrated in FIG. 14. The coherent PN code phase acquisition method acquires the PN code phase and PN code bit rate 300. In the second step, the complex multipath filter coefficients are programmed with the complex conjugate of the FWT data 310. In the third step, the PN generator(s) are initialized 320. The fourth step is locking of the PLL and despreading of the received data 330. Once these steps are complete, the code phase has been acquired and the signal being broadcast has been locked so that the base transceiver and the remote transceiver can exchange data.

For all or some of these steps, the input signal 200 is fed into a quadrature mixer/filter/amp 202 similar to those described above. The quadrature mixer/filter/amp 202 is driven by a programmable quadrature oscillator 203 which provides two reference signals nominally 90 degrees out of phase for the down conversion process as is well known in the art. The downconverted quadrature signals, I and Q, are fed into two ADCs, 204 and 205, which digitize the I and Q signals at a sample rate set by block 206. Block 206 provides a sample clock with a fixed phase relationship to the quadrature oscillator 203. In one embodiment, block 206 divides the quadrature oscillator clock by a fixed number to create a lower speed clock. Other phase, frequency or delay locked loops are well known in the art for accomplishing the same function and can be substituted for block 206 or 203.

In the first step of the coherent PN code phase acquisition method, acquiring the PN code phase and PN code bit rate 300, the quadrature oscillator and I and Q sampled signals are assembled into vectors of length 2^{N}−1 (the same length as the incoming PN M-sequence), reordered by permute functions 207 and 208, and then fed through two FWT blocks, one for each I and Q, 209 and 210. The outputs of the FWT blocks 209 and 210 are fed into a magnitude peak detector 211, which computes the RMS or other magnitude-like function of the FWT I and Q vectors on a point-by-point basis (i.e. 2^{N}−1 points in the resultant magnitude vector). The magnitude peak detector 211 then finds and records the sample rate and peak phase of the maximum magnitude point. When acquiring the PN code phase and PN code bit rate in step 300, the programmable sample rate and phase of the ADCs 204 and 205 and the frequency of the quadrature oscillator 203 are swept over a range of trial operating points. In one embodiment, the quadrature oscillator 203 and the divider 206 are independently varied. In another embodiment, the divide ratio M in block 206 is varied to maintain a deterministic phase relationship between the quadrature oscillator and the ADC sample rate as required for coherent detection. A PLL or DLL can also be used for similar independent or phase locked searches by substituting a PLL or DLL for 206.

The peak magnitude over the search ranges is determined by magnitude peak detect block 211, which sends the index to an unpermute function 214 to recover the PN code phase 219. The PN code phase 219 is used to initialize one or more PN generators 221, which are used later when initializing the PN generator(s) (step 320) to set up a PLL lock function and data recovery.

During the search, the FWT blocks' (209 and 210) outputs are captured in two random access memories (“RAM”) 212 and 213. Once the peak is known, a slice of 3D FWT search results 19 at the determined peak sample rate are read from the RAMs 212 and 213 using a selector 215. The selector returns the I and Q FWT results in the neighborhood of the peak PN code phase, both PN code phase and sub-PN-bit phase to cover both inter symbol multipath and intra symbol multipath effects. For example, if the designer requires three hundred nanoseconds of multipath filtering with a one hundred nanosecond PN code bit period and a 1 GHz ADC sample rate, the selector will return three hundred points (one hundred sub-PN-bit points multiplied by three PN code phases) which gives three hundred nanoseconds of one nanoseconds per step correlation results (complex). The 2D slice of FWT results 19 is serialized in the neighborhood of the peak FWT magnitude to recover a 1D multipath model that can optionally be longer than a single PN bit period. Each point of the recovered 1D multipath model corresponds to a sub-PN-bit phase step correlation shift, giving a high resolution sub-PN-bit multipath model. The output of the selector 215 is a complex multipath model of the channel with sub-PN-bit phase resolution.

The Q component of the multipath model is inverted by inverter 218 to form the complex conjugate of the selected FWT results that are then loaded into a complex matched multipath filter 220. Complex multipath filter 220 then does a complex correlation with the incoming signal data from the ADCs 204 and 205. In an alternative embodiment, the complex multipath filter is a complex RAKE filter. In a further embodiment, the RAKE tap coefficients are set to the complex conjugate of the M largest magnitude values in the neighborhood of the FTW peak as determined by peak detector 211.

In the third step 320, the PN code phase 219 acquired in the first step is used to initialize the code phase of one or more PN generators 221, which in turn drive their one or more generated PN codes into two or more correlators 222 and 223. The complex multipath filter 220 provides a complex I and Q filtered signal, which is correlated in correlators 222 and 223 to generate one or more signals which are fed to a tracking filter 225. In one embodiment, the correlators 222 and 223 perform early/late correlations and transmit a speedup/slowdown signal or signals to the tracking filter 225.

In one embodiment, the tracking filter 225 provides a correction signal to the quadrature oscillator 203, and by the fixed relationship between the quadrature oscillator 203 and the ADC sample clock divider/DLL/PLL 206, corrects the ADC sample rate as well. In another embodiment, the quadrature oscillator 203 is an independent free running oscillator.

The correlators 222 and 223 can also correlate the incoming multipath filtered data stream with other PN codes that are overlaid on top of the input signal 200 to encode a data stream. Such alternate data PN codes may be the same length as the phase acquisition code or a different length. In one embodiment, the PN code length of the acquisition is longer than the PN code length used for data transmission to prevent ambiguities in the data PN code phase and to reduce the size of errors due to noise in the filter coefficients. In another embodiment, the lengths of the acquisition and data PN codes are a multiple to reduce the complexity of the phase handoff between FWT and correlators.

The code lengths of the acquired PN code and the data PN code may be extended by one bit (i.e. 2^{N} long instead of 2^{N}−1) to maintain a simple multiple relationship in lengths. For example, a PN acquisition code could be 2048 bits long and a data PN code could be 512 bits long, which are related by a factor of 4. Alternatively, if the acquisition PN code is longer than the data PN code, a group of sequential data PN codes can be padded with additional bits to equal the length of the acquisition PN code. The correlators 222 and 223 and the PN generator(s) 221 can appropriately advance or retard the data PN codes appropriately to maintain data extraction phase. For example, if the acquisition PN code length is 2047 (=2¹¹−1) and the data PN code length is 511 (2⁹−1), four data codes can be assembled with 3 of them padded with an extra bit to match the length of the acquisition PN code (e.g. 512+512+512+511=2047).

Those of skill in the art will recognize that the various embodiments disclosed herein are susceptible to various modifications and alternative forms, and specific examples thereof have been shown by way of example in the drawings and are herein described in detail.

1. An apparatus for code phase acquisition comprising:
an oscillator;
an analog to digital converter that receives a baseband signal, said analog to digital converter sampling said baseband signal at a rate controlled by said oscillator;
a fast Walsh transform engine that receives a permuted output of said analog to digital converter and outputs an output vector; and
a peak detector that detects peaks in said output vector.

2. The apparatus of claim 1 wherein said baseband signal is created by an envelope detector.

3. The apparatus of claim 1, wherein said peak detector comprises a plurality of correlators.

4. The apparatus of claim 1 wherein said output vector from said peak detector has an unpermute function applied thereto so that a peak position can be mapped into a code phase.

5. The apparatus of claim 1 wherein the output of said analog to digital converter comprises a vector of 2^{N}−1 sequential samples, thereby creating an M-sequence having a length of 2^{N}−1 samples.

6. The apparatus of claim 5 wherein said output vector has said peak at a dominant psuedo noise code phase of said M-sequence.

7. The apparatus of claim 1 wherein the oscillator is a programmble oscillator.

8. The apparatus of claim 1 wherein the oscillator is a variable oscillator.

9. A method for acquiring a radiofrequency signal from a remote radiofrequency transceiver wherein said remote radiofrequency transceiver broadcasts a signal having a pseudo noise code phase and pseudo noise code bit rate, comprising:
performing a fast Walsh transform on the radiofrequency signal that has been digitized to acquire the pseudo noise code phase and the pseudo noise code bit rate of the radiofrequency signal;
determining multipath filter coefficients from results of the fast Walsh transform; and
initializing a pseudo noise generator with the pseudo noise code phase acquired during the fast Walsh transform step;
tracking the pseudo noise code phase and pseudo noise code bit rate to maintain communication with the radiofrequency signal.

10. A method for acquiring a sub-PN-bit phase of a M-sequence PN coded pulsed signal, comprising:
generating a vector of sequential samples from a digitized and permuted M-sequence PN coded pulse signal;
performing a fast Walsh transform on said vector;
detecting peak output(s) of the fast Walsh transform; and
mapping the peak output(s) into a code phase, the peak output(s) corresponding to a beacon signal indicative of a signal to be acquired.

11. A method for acquiring a pulsed radiofrequency signal having sample rates and sub-sample phases and encoded with a predetermined code sequence, comprising
scanning over all the sample rates and the sub-sample phases that cover a time range of interest;
at each sample rate and sub-sample phase, accumulating samples;
performing a fast Walsh transform of said samples; and
for each sample rate and sub-sample phase, determining correlations to the predetermined code sequence within said samples, a largest of the correlations corresponding to the phase of the predetermined code sequence to be acquired.

12. The method of claim 11 wherein the predetermined code sequence is a pseudo noise code.

13. A method for acquiring a beacon signal broadcast from a remote radiofrequency transceiver, wherein said beacon signal has a pseudo noise code phase, comprising:
performing a fast Walsh transform on a pulsed radiofrequency signal that has been digitized, thereby creating an output vector;
detecting a peak in the output vector
unpermuting the peak to find pseudo noise code phase;
tracking the pseudo noise code phase to maintain communication with the beacon signal; and
despreading of the noise code phase and pseudo noise code bit rate to recover any data in the radiofrequency signal.
